(19) United States
(12) Patent Application Publication
(10) Pub. No.: US 2004/0238335 A1
(43) Pub. Date: Dec. 2, 2004

(54) Tray carrier for use in mogul machine

(75) Inventor: Jerome A. Salois, Roscoe, IL (US)

Correspondence Address: LEYDIG VOIT & MAYER, LTD, 6815 WEAVER ROAD, ROCKFORD, IL, 61114-8018, US

(73) Assignee: Liberty Engineering Company, Roscoe, IL (US)

(21) Appl. No.: 10/448,244

(22) Filed: May 29, 2003

(51) Int. Cl. B65G 29/00

(52) U.S. Cl. 198/867.15

(57) ABSTRACT

The invention provides a tray support plate assembly instead of a single cast unitary part for a tray carrier used in a mogul machine. The high wear or failure areas of the tray support plate assembly have been designed as removable and replaceable separate parts that are fastened onto the tray support plate. The support plate may be machined from aluminum billet material. The individual parts such as the end pick plate may also be made of aluminum plate material. Preferably the cam plate is made of steel material. A pair of cam mechanisms can be provided on opposed sides of the tray support plate.

### FIELD OF THE INVENTION

This invention pertains to mogul machines that are used for making starch molded candy products, and more particularly to tray carriers for use on such mogul machines.

### BACKGROUND OF THE INVENTION

Mogul machines are used for making starch molded candy products such as gummy bears for example. The machines typically include a central horizontal conveyor that systematically moves the trays through different stations where trays are filled with starch, cavities are printed into the starch and the cavities are filled with liquefied candy product mixture. At least one end of the machine includes a tray transport mechanism that may be used to pick trays from the horizontal conveyor. An example an exemplary mogul machine is disclosed in Klein, U.S. patent application Ser. No. 09/871,828 assigned to the present assignee, the entire disclosure of which is hereby incorporated by reference.

This invention pertains to the tray carrier devices used in the tray transport mechanism at the end of the mogul machine. This tray transport mechanism includes a pair of parallel endless chains that run around endless paths that have both horizontal and vertical segments. The endless chains carry a plurality of tray carrier mechanisms. Tray carrier mechanisms of opposing endless chains cooperate to pick and transport trays along the endless path as desired (with trays held between opposed tray carrier mechanisms).

There are a large number of mogul machines in existence and as such the design for tray carrier mechanisms has basically remained constant. Prior tray carrier mechanisms have only been made of a couple of parts. The part that engages trays have traditionally been cast as a single unitary part from cast iron material. While tray carriers with this design usually work well for a while, from time to time, these devices need to be replaced as portions of the single unitary cast iron mass become bent, break off and/or become worn. Unfortunately, replacing and maintaining the individual tray carrier mechanisms has become expensive and has resulted in significant downtime. Because there are a large number of mogul machines in existence using this design, heretofore, there has been no suitable solution to these problems.

### BRIEF SUMMARY OF THE INVENTION

The invention provides a solution to the problems with existing tray carrier mechanisms by providing a tray support plate assembly instead of a single cast unitary part. The high wear or failure areas have been designed as removable and replaceable parts that are fastened onto the tray support plate. The individual replaceable parts such as the support plate may be machined from aluminum billet material. The end pick plate may also be made of aluminum plate material. Preferably the cam plate structure is made of steel material. A pair of cam plates can be provided on opposed sides of the tray support plate.

These and other advantages of the invention, as well as additional inventive features, will be apparent from the description of the invention provided herein.

### BRIEF DESCRIPTION OF THE DRAWINGS

FIG. 1 is a side elevation partly schematic illustration of a mogul machine having tray transport mechanisms which may incorporate the present invention.

FIG. 2 is an isometric illustration of a tray transport mechanism incorporating tray carriers in accordance with the present invention.

FIG. 3 is a plan view of a tray carrier in accordance with the present invention.

FIG. 4 is a side elevation of the tray carrier shown in FIG. 3.

FIG. 5 is side elevation similar to that shown in FIG. 4 but in an expanded position.

FIG. 6 is a cross section of FIG. 3 taken about line 6-6.

FIG. 7 is an exploded isometric view of the tray carrier shown in the previous Figures.

### DETAILED DESCRIPTION OF THE INVENTION

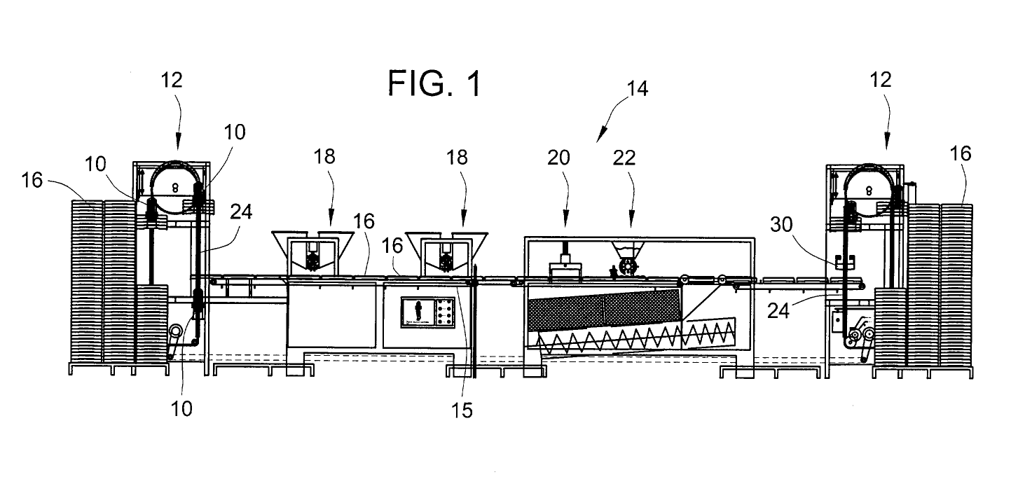

Referring to FIG. 1, a tray carrier 10 is shown used in a tray transport mechanism 10 disposed at the end of a mogul machine 14. The mogul machine 14 may be the same machine as that disclosed in U.S. patent application Ser. No. 09/871,828, and reference can be had to that application for some additional details of an exemplary mogul machine arrangement. Because mogul machines are well known, only limited details will be provided herein for purposes of orientation of the drawings and the present invention. The mogul machine 14 includes an entrance side that receives empty trays 14 on a horizontal conveyor mechanism 15. The conveyor mechanism 15 transports trays 16 through a plurality of stations including starch filling and leveling stations 18, a candy cavity printing station 20 where cavities are formed into the starch contained in the tray, and one or more candy pumping stations 22 where liquidized candy mixture is filled into formed cavities. Trays are then output onto the tray transport mechanism 12 where the molded candy is separated from the starch.

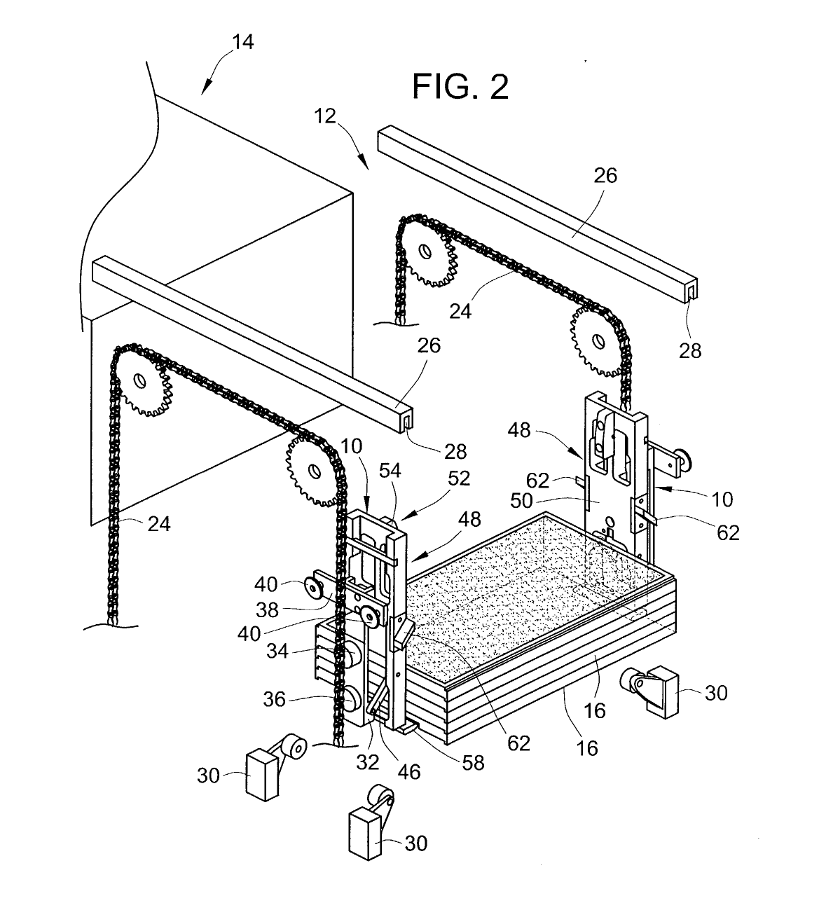

The tray transport mechanism 12 for which the present invention is directed may be disposed at one or both ends of the conveyor mechanism 15. As shown in FIG. 2, the tray transport mechanism 12 includes a pair of endless chains 24 that are entrained on sprockets in parallel relation and that are driven about an endless path to include vertical and horizontal segments. Each chain 24 includes a plurality of the tray carriers 10 that are arranged at spaced intervals along the endless path. The tray carriers 10 of opposed endless chains are aligned with one another to cooperate to pick and transport trays 16 along the endless path. Arranged along the path are linear guide rails 26 that define guide tracks or channels 28 that are adapted to guide movement and keep correct alignment of the tray carriers 10. The tray transport mechanisms 12 also include cam activators or abutment blocks 20 that are adapted to engage cam mechanisms on the tray carriers 10.

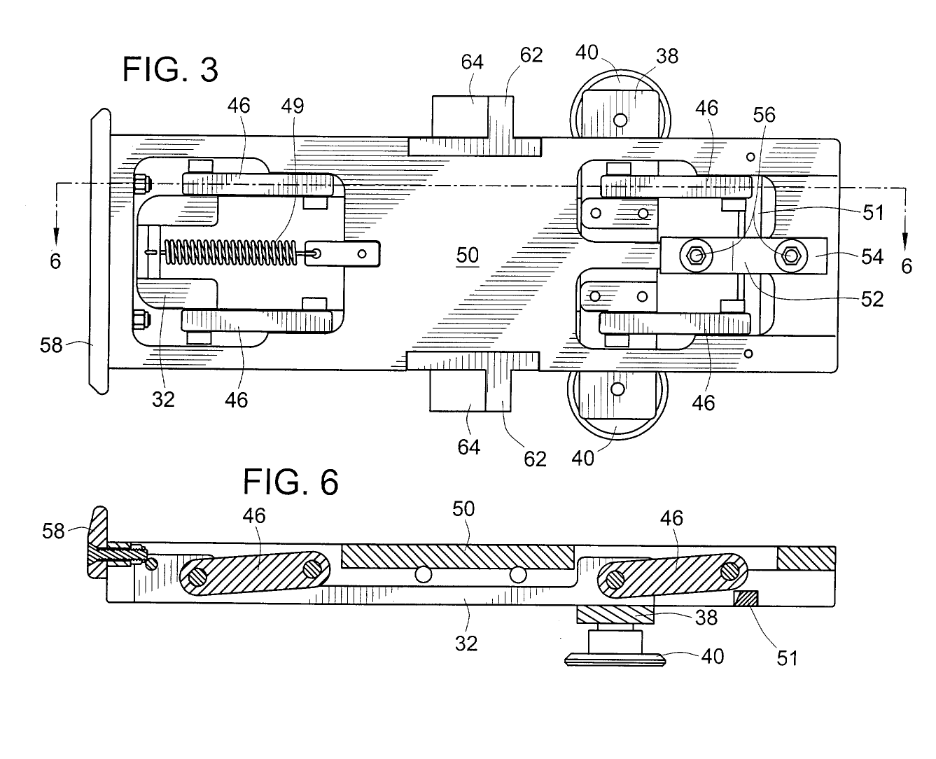

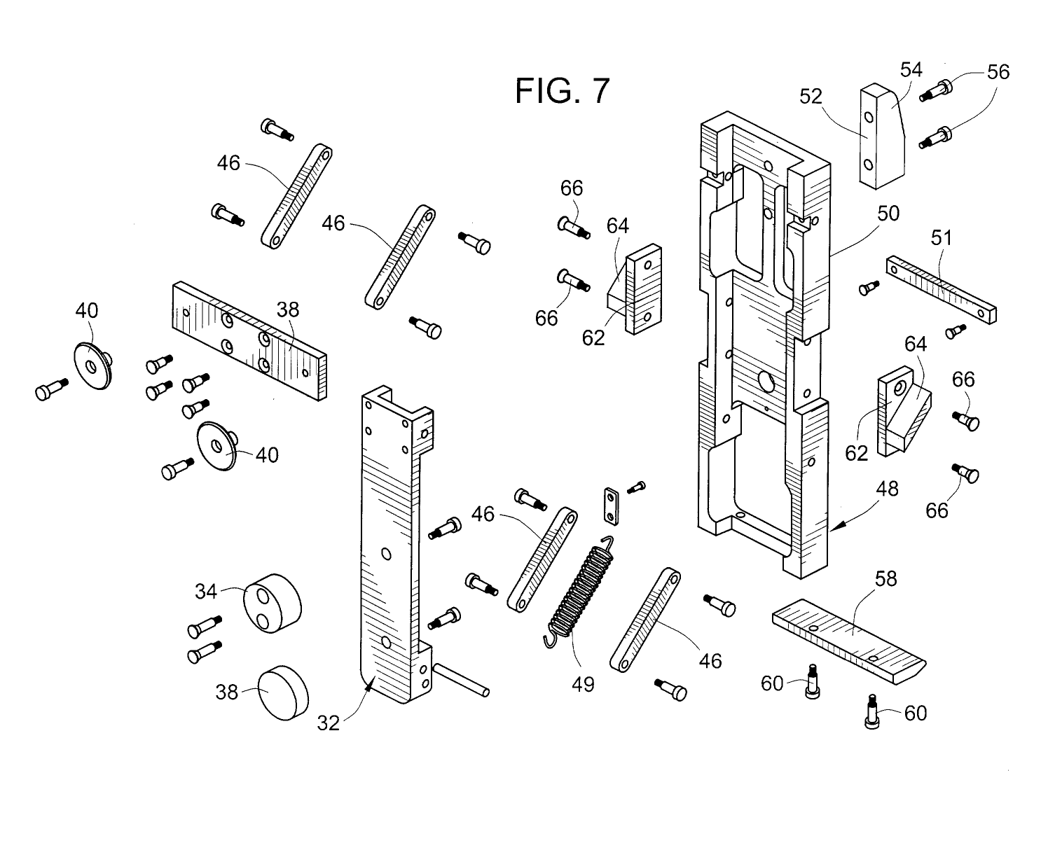

Turning in greater detail to the present invention, the tray carrier 10 shown in FIGS. 3-7 has several novel features that provide for easier and/or less expensive maintenance and which can be used to replace cast iron tray carriers existing on many mogul machines. The tray carrier 10 includes a mounting base 32 that is the primary support structure for the apparatus. The mounting base 32 may be machined from a block of billet aluminum material and extends generally along a longitudinal vertical path axis. Along the outer face of the tray carrier 20, a chain mounting structure 34 is rotatably mounted the mounting base 32. The mounting structure 34 includes a pair of threaded holes that can be fastened directly to the endless chain 24 with suitable fasteners. In spaced relation to the chain mounting structure 34 along the path axis is a rounded cylindrical chain engagement slide block 36 mounted the mounting structure. The slide block 36 is adapted to engage the chain 24 and keep the tray carrier 10 in an upright position.

In addition, a cross block 38, which also may be machined from aluminum billet material, is mounted to the mounting base 32. The mounting base 32 extends along a horizontal axis transverse to the vertical axis and carries a pair of guide wheel followers 40 at opposed ends with one on each side of the mounting base. The guide wheels followers 40 may be removably fastened to the cross block 38 and are adapted to be received in the channels 28 of the guide rails 26 to keep the tray carrier 10 in a correct alignment position.

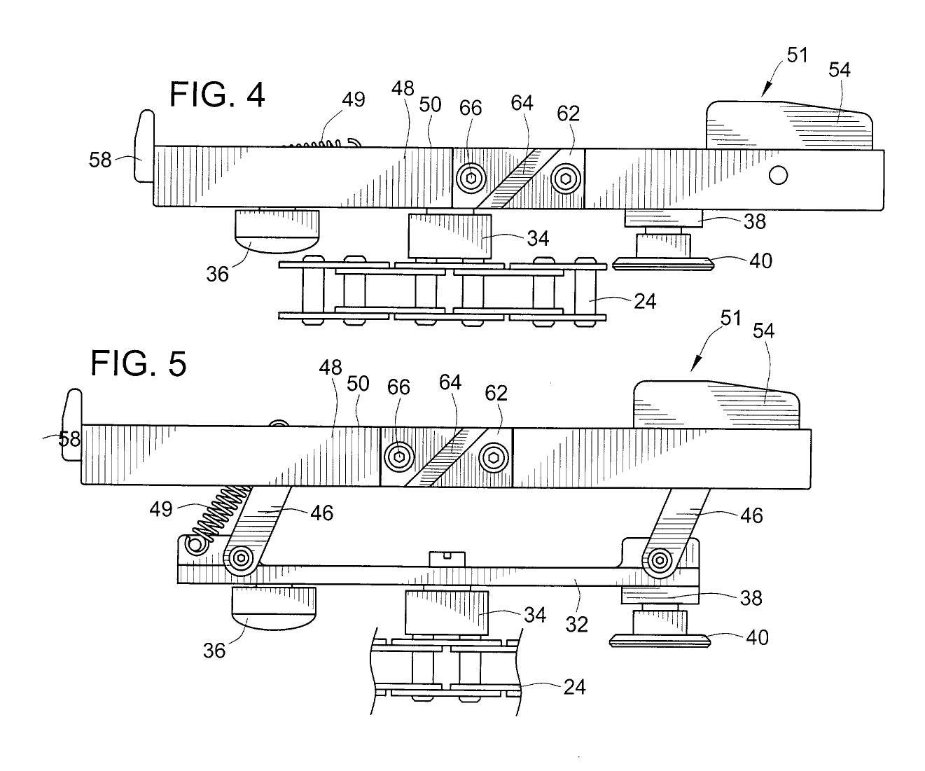

A front pair and a back pair of pivot arms 46 arranged in a rectangular spacing are pivotally mounted to the mounting base 32 via shoulder bolts. The pivot arms 46 are pivotally connected to a tray support plate 48 via shoulder bolts and thereby carry the tray support plate 48 in parallel relation to the mounting base 32. As shown in the FIGS. 4 and 5, the tray support plate 48 is movable or swings away and simultaneously reward relative to the mounting base 32 through the pivot arms 46.

In FIG. 4, the tray support plate 48 is illustrated in a forward position adjacent the mounting base 32, while in FIG. 5, the tray support plate 48 is illustrated in a rearward position spaced horizontally from the mounting base 32. When mounted upright, gravity is one force that tends to keep the tray support plate 48 in the away position shown in FIG. 5. In addition, at least one spring 49, supported by the mounting base 32, is arranged to bias the tray support plate 48 rearwardly. When the carrier is positioned as shown in FIG. 5, the spring 49 serves to hold the tray support plate 48 in the away position and a fixed position against a stop plate 51 mounted to the tray support plate 48. Also, when the tray support plate 48 is in a close or forward position, it is in an over-center position meaning that the spring also serves to hold the tray support plate 48 in the close position. As will be described below, the tray support plate 48 is actuated against the action of the spring 48 between close and away positions when cam plates are acted upon by stationary abutment blocks 30.

The tray support plate 48 includes a planar tray contact face 50 that faces in a direction away from the mounting base 32 and that is adapted to engage trays 16 when mounted on one of the endless chains 24 of the tray transport mechanism 12.

At the forward end of the tray support plate 48 is a removable slide block 52, which may be machined from industrial plastic material. The slide block 52 is intended to be the first structure to engage the trays and as such preferably includes a chamfered front face 54 that is adapted initial engage each tray. The slide block 52 is removably mounted with fasteners 54 to the tray support plate 48.

At the rear end of the tray support plate 48, and in accordance with an aspect of the present invention, is a removable butt end pick plate 58. The pick plate 58 may be machined from aluminum billet material. The pick plate 58 is fastened to the back side of the tray support plate 48 in a removable manner with threaded fasteners 60. The pick plate 58 projects outward from the contact face 50 away in a direction away from the mounting base 32 to engage the bottom side of tray 16. In this manner, the pick plate 58 is adapted to support and support the trays 16.

It is an advantage of the present invention that the pick plate 58 is made separate from the tray support plate 48 and is removably fastened thereto. One benefit is that the pick plate 58 can be removed and replaced from time to time after excess wear has occurred or if the pick plate 58 breaks or becomes disfigured. Because the pick plate 58 strikes the bottom side of trays and thereby carries the brunt of the initial impact, the removability feature provides a ready way to maintenance the tray carrier 10 without completely disassembling the device and removal of the device from the endless chain may not be necessary.

In accordance with another aspect of the present invention, one or more side cam plates 62 are mounted to opposing sides of the tray support plate 48. The cam plates 62 include diagonal cam faces 64 that are adapted to strike the stationary abutment blocks 30 which are arranged at strategic locations for purposes of picking and releasing trays. The cam plates 62 are preferably made of steel material to be of suitable hardness for the abutment blocks 30. The cam plates 62 are also removably fastened to the tray support plate 48 with thread fasteners 66 such that the cam plates 62 can be readily replaced. This is another significant advantage as the cam plates 62 repeatedly contact the abutment blocks 30 and thereby incur large impact loads and stress during each cycle of the device. The cam plates 62, can likewise be replaced without completely disassembling the tray carrier 10 and maintenance, repair and replacement of cam plates 62 can be done while the tray carrier 10 is mounted to an endless chain if desired.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tray carrier adapted to be removably mounted to an endless chain for use in a mogul machine, the tray carrier comprising:
a mounting base;
a chain mounting structure attached to the mounting base for attaching the mounting base to the endless chain;
a tray support plate arranged in spaced relation to the mounting base having a tray contact face facing away from the mounting base;
a plurality of support arms pivotally connected to the mounting base and pivotally connected to the tray support member, wherein the tray support plate is movable through the support arms toward and away from the mounting base;
at least one spring supported by the mounting base biasing the tray support plate rearwardly;
a removable slide block fastened to the tray support plate; and
a removable pick plate fastened to the tray support plate and spaced behind the leading slide block.

2. The tray carrier of claim 1, further comprising a cross bar mounted to the mounting base and extending horizontally, and a pair of guide followers mounted near opposing ends of the cross bar.

3. The tray carrier of claim 1, wherein the removable slide block and the removable pick plate are fastened with screws to the tray support plate.

4. The tray carrier of claim 1 wherein the tray support plate and the pick plate are manufactured from aluminum billet material.

5. The tray carrier of claim 6 wherein the slide block is made of plastic material.

6. The tray carrier of claim 1, further comprising a pair of removable cam bodies fastened to opposed sides of the tray support base, the cam body defining a cam surface configured for engagement with an external element to move the tray support plate relative to the mounting base.

7. A tray carrier adapted to be removably mounted to an endless chain for use in a mogul machine, the tray carrier comprising:
a mounting base;
a chain mounting structure attached to the mounting base for attaching the mounting base to the endless chain;
a tray support plate arranged in spaced relation to the mounting base having a tray contact face facing away from the mounting base;
a plurality of support arms pivotally connected to the mounting base and pivotally connected to the tray support member, wherein the tray support plate is movable through the support arms toward and away from the mounting base;
at least one spring supported by the mounting base biasing the tray support plate rearwardly; and
a cam body fastened to the tray support base, the cam body defining a cam surface configured for engagement with an external element to force the tray support plate away from the mounting base.

8. The tray carrier of claim 7, further comprising:
a removable slide block fastened to the tray support plate; and
a removable pick plate fastened to the tray support plate and spaced behind the slide block.

9. The tray carrier of claim 8, wherein the removable slide block and the removable pick plate are fastened with screws to the tray support plate.

10. The tray carrier of claim 7, further comprising a cross bar mounted to the mounting base and extending transverse relative to the path axis, an a pair of guide followers mounted near opposing ends of the cross bar.

11. The tray carrier of claim 7 wherein the tray support plate is manufactured from aluminum billet material.

12. The tray carrier of claim 1, further comprising a second cam body fastened to the tray support base in spaced relation to said first cam body, the second cam body defining a cam surface configured for engagement with an external element to move the tray support plate relative to the mounting base.
